(19) United States
(12) Patent Application Publication
(10) Pub. No.: US 2018/0177324 A1
(43) Pub. Date: Jun. 28, 2018

(54) EGG COOKING UTENSIL

(71) Applicant: Brian Powell, Shropshire (GB)

(72) Inventor: Brian Powell, Shropshire (GB)

(21) Appl. No.: 15/900,657

(22) Filed: Feb. 20, 2018

Related U.S. Application Data
(63) Continuation-in-part of application No. 12/515,840, filed on May 21, 2009, now abandoned.

(51) Int. Cl. A47J 29/02

(52) U.S. Cl. CPC A47J 29/02

(57) ABSTRACT

An egg cooking appliance having a first recess for the receipt of water. The first recess further includes a first heater positioned below the first recess. A second recess the for the receipt of at least one de-shelled egg, further having a second heater positioned below the second recess. A temperature sensor is affixed to the second recess and distanced from the second heater. A processor is provided for the receipt of input from a user and from the temperature sensor for providing output to the first and second heaters, and a lid sized to substantially cover the first and second recesses and for passage of steam from the first recess to the second recess and for expelling steam from the appliance.

### RELATED APPLICATIONS

The present application is a Continuation In Part of U. S. application Ser. No. 12/515,840 filed on May 21, 2009 based upon International Application WO 2008/068457 filed on Nov. 21, 2007.

### TECHNICAL FIELD

The present invention is directed to an apparatus for the controlled and optimized cooking of eggs employing not only direct convective heat but also by steam. The apparatus is capable of providing the user with a variety of cooking programs while optimizing cooking parameters and minimizing the expenditure of energy required to complete the cooking process.

### BACKGROUND OF THE INVENTION

The prior art has recognized that one can cook eggs using the combination of convection heating and steam. For example, reference is made to U. S. Pat. No. 3,704,663 which teaches an egg cooker of the skillet type having a central water compartment for generating steam for basting and a plurality of separate cooking compartments each of fried egg size for receiving shortening and the yolk and white of an egg. The device includes a removable cover which when in place is spaced from the open tops of the water and cooking compartments, whereby steam produced in the water compartment is directed to the upper surface of the eggs in the cooking compartments producing cooked eggs having the appearance and texture of poached eggs and the flavor of fried eggs. However, this skillet, being typical of prior art, provides for no controls recognizing the skillet is intended to be placed simply upon a cooktop with the same energy source used for both cooking the eggs and converting water in the water compartment to steam or two heaters but devoid of controls. Such devices also have no means of dealing with eggs of varying masses or for dealing with cooking preferences. Commonly, the prior art teaches the use of a frying pan which may include sensors built within their handles but such devices have no stream controls or are they programmable.

Although the casual user may not give a good deal of thought to variables which can dramatically affect an end product, appliances of this type must either deal with such issues or the result will be anything but acceptable. For example, typical eggs have a mass from 50 g to 90 g requiring cooking times from 45 seconds to three minutes dependent on the cooking method. For example, a fully cooked egg takes longer to achieve than one which is soft poached. As such, if a user wished to have a fully cooked egg assuming that the egg was 50 g, the result would not be achieved if the egg was, in fact, 90 g assuming constant cooking parameters of power and time. In addition, the end result would vary greatly depending upon whether the de-shelled egg was loaded into a cold receiving plate in contrast to one which was preheated. When an egg is introduced to such a device, its temperature drops. The control of this and the associated boost control is important as it maximizes the time available to cook the egg. If steam generation was not controlled by virtue of the heating element associated with the water receiving plate, energy would be wasted as constant (uninterrupted) power is not necessary for when brought to the appropriate temperature, the energy stored in the plate will cause steam generation even if power was interrupted. Although it is recognized that steam production requires that the aluminum plate that holds the egg and water must be at 100° C., continuous power could over heat the egg plate and produce steam too quick by requiring, per the present invention, adjustment of the power. Various prior approaches have also not accounted for certain safety issues. For example, a successful device must account for the steam generating plate being devoid of water and the egg receiving plate being devoid of an egg.

It is thus an object of the present invention to provide an egg cooking appliance which addresses the deficiencies of the prior art.

It is still a further object of the present invention to provide an egg cooking appliance which is programmable by a user as to the size of the egg or eggs to be cooked and desired end result such as an egg which is soft poached, fully cooked or souffléd providing for repeatable results.

It is yet an additional object to the present invention to provide an egg cooking appliance which is capable of operating while minimizing the power necessary to accomplish its desired results.

It is yet a further object of the present invention to provide an egg cooking appliance that can be set to operate at a fixed period of time but employing an egg detecting protocol to control desired cooking results.

These and further objects be more readily appreciate when considering the following disclosure and appended claims.

### SUMMARY OF THE INVENTION

An egg cooking appliance comprising a first recess for the receipt of water, said first recess further comprising a first heater positioned below said first recess;

a second recess for the receipt of at least one de-shelled egg, further comprising a second heater positioned below said second recess, said first and second heaters being either separate elements or a single continuous element below both first and second recesses a temperature sensor affixed to said second recess and distanced from said second heater; a processor for the receipt of input from a user and from said temperature sensor for providing output to said first and second heaters; and

a lid sized to substantially cover said first and second recesses and for passage of steam from said first recess to said second recess and for expelling steam from said appliance. An egg cooking appliance comprising a first recess for the receipt of water, said first recess further comprising a first heater positioned below said first recess;

a second recess for the receipt of at least one de-shelled egg, further comprising a second heater positioned below said second recess, said first and second heaters being either separate elements or a single continuous element below both first and second recesses a temperature sensor affixed to said second recess responsive to the temperature of said second recess and distanced from said second heater;

a lid sized to substantially cover said first and second recesses and for passage of steam from said first recess to said second recess and for expelling steam from said appliance; a processor;

a keypad providing user—selected output of egg sizes and cooking preferences to said processor;

said processor activating said second heater for initiating pre-heating of said second recess; and

said sensor providing temperature information to said processor.

### BRIEF DESCRIPTION OF THE FIGURES

FIG. 1 is a top plan view of the cooking appliance of the present invention devoid of sensors, heaters or controls.

FIG. 2 is a cross-sectional view of the appliance of FIG. 1 taken along line 2-2 thereof.

FIGS. 3A-3C are top plan views of additional examples of the cooking appliance of the present invention devoid of controls.

FIG. 4 is a cross-sectional view of the example of FIG. 3C including the positioning of the lid thereon.

FIG. 5 is a schematic illustration of the process or controlled sequence carried out in employing the present cooking appliance.

FIG. 6 is a schematic layout of a typical two-plate cooking apparatus of the present invention.

FIG. 7 is a cooking cycle graph to enable one to more readily visualize the operation of the present cooking appliance.

### DETAILED DESCRIPTION OF THE INVENTION

Novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration description only and are not intended as definitions of the limits of the invention. The various features of novelty which characterize the invention are recited with particularity in the claims.

There has been broadly outlined more important features of the invention in the summary above and in order that the detailed description which follows may be better understood, and in order that the present contribution to the art may be appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important therefore, that claims be regarded as including such equivalent constructions insofar as they do not depart from the spirit and scope of the present invention.

Certain terminology and the derivations thereof may be used in the following description for convenience and reference only, and will not be limiting. For example, words such as “upward,” “downward,” “left,” and “right” refer to directions in the drawings to which reference is made unless otherwise stated. Similar words such as “inward” and “outward” refer to directions toward and away from, respectively, the geometric center of a device or area and designated parts thereof. Reference in the singular tense include the plural and vice versa, unless otherwise noted.

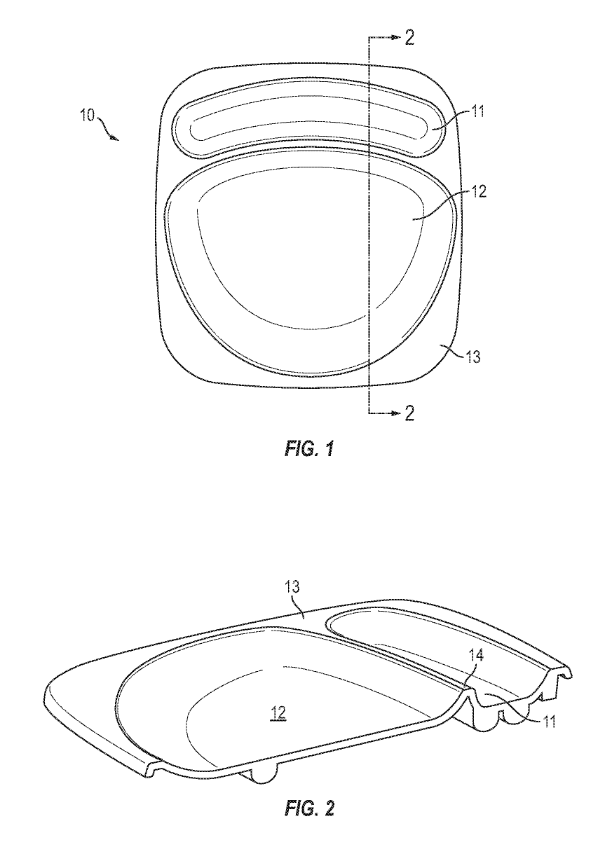

Turning first to FIGS. 1 and 2, appliance 10 is illustrated having first recess 11 for the receipt of water and second recess 12 for the receipt of one or more de-shelled eggs configured within a simple plate 13. In order to provide up to 180 seconds of steam production, recess 11 should have the capacity to receive at least 20 ml of water although, in most instances, a complete cooking cycle for a soft poached egg can be completed with only 1 teaspoon (5 ml) of water introduced to first recess 11 at the outset of a cooking cycle. Also, for the appropriate recess to receive at least one de-shelled egg, recess 12 should have a depth of approximately 10 mm and a capacity of approximately 100 ml.

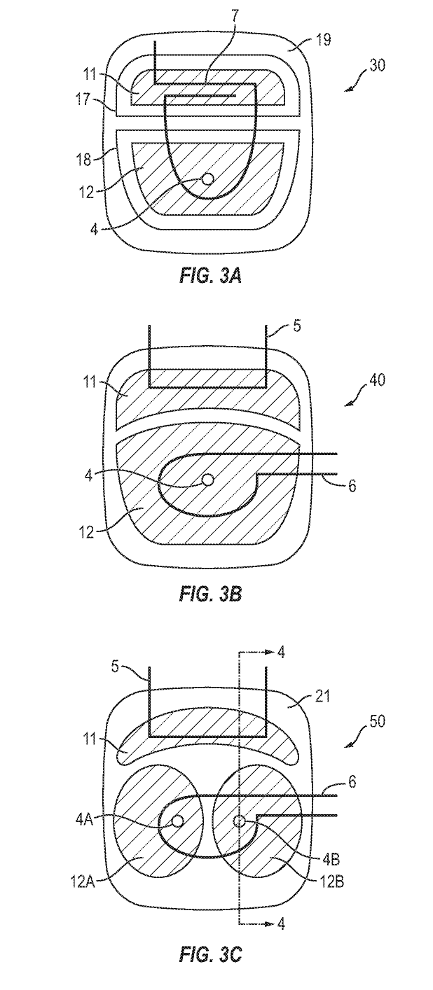

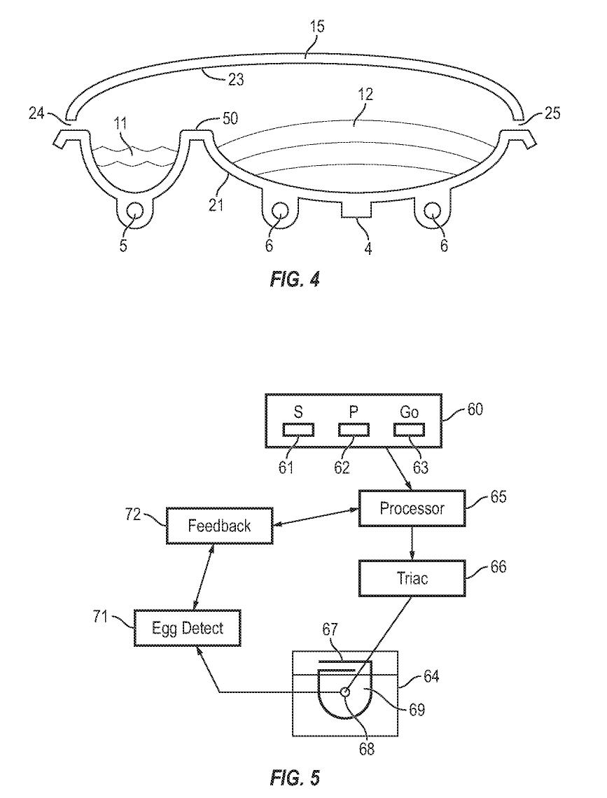

The present appliance is configured to provide heaters below the first and second recesses as well as a temperature sensor below the second recess and which is spaced from the heater so as to properly sense the temperature of recess 12 without interference from the configured heating element. In this regard, reference is made to FIGS. 3A-3C and 4 as examples of such appliances.

In turning to FIG. 3A, plate 30 is shown having first recess 11 and second recess 12. Heater 7, such as a Bundy heater, passes beneath recess 11 to recess 12 terminating in recess 11. Temperature sensor 4 is centrally located beneath recess 12. It is noted that recess 11 is configured within plate 17 as well as recess 12 configured within plate 18 as contracted to the single plate embodiment in FIGS. 1 and 2. Plates 17 and 18 are separate parts of the appliance and are received within frame 19 to enable plates 17 and 18 to be removed from frame 19 for cleaning, replacement and servicing. As noted in reference to

FIG. 3B, plate 40 includes heater 5 passing beneath first recess 11 which is separate from heater 6 which passes beneath second recess 12 and which provides for increased flexibility by enabling the independent control of heaters 5 and 6 when desired. FIG. 3C illustrates yet a further embodiment whereby two recesses 12A and 12B are configured within plate 21 for the receipt of de-shelled eggs noting further that temperature sensor 4A is located beneath recess 12A and temperature sensor 4B is located beneath recess 12B.

Appliance 50 is illustrated as cross-section 4-4 of FIG. 3C in FIG. 4. It is noted that first heating element 5 is positioned with respect to the geometry of first recess 11 such that as long as there is water in first recess 11, the water is always proximate to first heater 5. In other words, the water is always reduced to the heater. Second heater 6 positioned below and configured within a second recess 12 is distanced from temperature sensor 4 which can be, for example, a glass bead thermistor. Also note that the shape of the second recess 12 always locates the egg on the sensor. The appliance further includes lid 15 which can be hinged to plate 21 noting that bottom surface 23 thereof is spaced from the top surface of plate 50 to enable steam generated within first recess 11 to pass into second recess 12. In addition, in providing plate 50 as one composed of aluminum having a typical thickness of approximately 2 mm and lid 15 being composed typically of stainless steel, when steam is generated within first recess 11, some of said steam passes through gaps 24 and 25 as lid 15 slightly rises above plate 50 when sufficient steam pressure is generated.

As mentioned previously, the present egg cooking appliance is capable of cooking de-shelled eggs to a user's preference efficiently and with the appropriate safeguards to ensure not only repeatability of an appropriate cooking cycle but also that energy is conserved and the device operates safely. In this regard, reference is made to FIG. 5.

A typical user will have at his or her disposal keypad 60 having switches 61, 62 and 63. Most eggs can be characterized as small, medium and large. The appropriate egg size is first selected by engaging switch 61. The user would then select the appropriate program which, in this instance, is composed of soft poached (shortest), fully cooked and souffléd (longest). Once the desired selections are made, a user would then depress the “go” button 63. Triac 66 is powered by the output of processor 65 begins activating Bundy heater 67 passing beneath plate 64 having recess 69 intended to receive one or more de-shelled eggs. A preheat temperature is achieved within recess 69 and will be maintained for a specific period of time, typically two minutes. It should be noted that the output from sensor 68 is fed to detector 71 providing feedback through 72 to enable processor 65 to know whether a de-shelled egg is contained within recess 69. Stated differently, the processor predicts the appropriate temperature for a set amount of energy input which is checked multiple times per second to determine if the temperature rise within recess 69 is appropriate for plate 64 devoid of any de-shelled egg. If the temperature rise within plate 64 is too great after the passage of a given period of time, power to heating element 67 is shut down but if appropriate, power passes to heater 67 as the preheat cycle continues.

Once the pre-heat temperature is reached for example 80° C. water is added to the water section. Typically 5ml of water is enough to complete a poach program. The water does not cause a temperature drop on the sensor but the egg does.

As noted in reference to FIG. 7, a typical program of the present cooking cycles is depicted.

The boost control detects the egg by detecting a temperature drop typically 3 degrees in one second.

The BST or boost control calculates from the button settings the best delay (temperature drop) for the start of inputting boost power at 100%. The boost energy energises the heater to drive the plate temperature above 100° C. to start steam production. The boost calculation is (Tt−Ta)/3.5 or 80−30/3.5=14.5 seconds of 100% power. Whereby Tt is the target temperature and Ta the actual temperature. Thereupon the cooking cycle continues with a period of power for a defined period, say 75% for 15 seconds and a 2^{nd} cooking period of 35% for 30 seconds to complete 45 seconds of cooking. This is suitable to poach a medium sized egg. A dwell or waiting time can be included with no power input so that the steam production is slowed down and the plate reduces in temperature to get ready for the next cooking cycle. The goal is to enter the dwell period with no water remaining.

If the next cycle starts immediately and water and an egg are loaded the button settings are used by the boost control and will allow a greater temperature drop in order allow a greater cooking time rise under the plate and hence a longer duration of steam production. The boost can start within one second or can be delayed by several seconds. However a 60° temperature drop is seen as about the maximum.

In addition to the previous cooking method there is a requirement to detect the egg when the egg and plate are at or near the same temperature because egg drop may not be detected.

This could also happen by accident as the appliance has not been switched on.

When the plate and egg are at or near the same temperature there may not be a 3 degree temperature drop.

The water and egg are loaded. The size and program buttons are selected, the go button is pressed. The processor inputs power to get to a desired pre-heat temperature. The sensor is monitored many times each second. Due to empirical testing and the heat transfer equation (Q=mass×C×temp rise). The temperature rise can be predicted and should occur without an egg in the egg plate. The pre-heat power needed is Tt−Ta/5=100−20/5=16 seconds. Power is input for a pre-heat after 5 seconds; without an egg in the plate the temperature should be at 45° C. If an egg is present the temperature will be noticeable lower. Next the egg is detected and the pre-heat phase gets adjusted with a boost calculation of Tt−Ta/3.5. or 100−35/3.5=18.6 seconds requiring considerable more power. After this boost phase the cooking phases 1 and 2 are entered as described previously. (For example 75% for 20 seconds and 45% for 30 seconds.) There is another instance when low temperature detect is also needed, that is, when the water and egg are loaded during the pre-heat phase but before attaining pre-heat temperature. If the egg drop control does not detect the egg then the low level egg detect will detect the egg and a new boost calculation is made. At an over temperature say when the plate is getting towards 140° C. to fast (for safety). The power input is slowed or stopped. This allows the temperature of the egg plate and heater plate to equalize noting that a plate temperature of 120° C. or above is sufficient to continue to make steam, although this discussions is made to exemplify one use of the present appliance and in doing so, one should not conclude that the invention is limited to such cooking strategies.

Although not restricted to any particular parameters, for the sake of providing a second framework as to the time and temperature anticipated for cooking eggs of various sizes, reference is made to the following table:

| | Poach | | Fast | | Soufflé | |
|---|---|---|---|---|---|---|
| Small Egg | Pre-heat 60° C. | | 100° | C. | 70° | C. |
| | Cook time 60 secs | | 80 | secs | 120 | secs |
| Medium Egg | 60° | C. | 100° | C. | 70° | C. |
| | 80 | secs | 100 | secs | 150 | secs |
| Large Egg | 60° | C. | 100° | C. | 70° | C. |
| | 100 | secs | 120 | secs | 180 | secs |

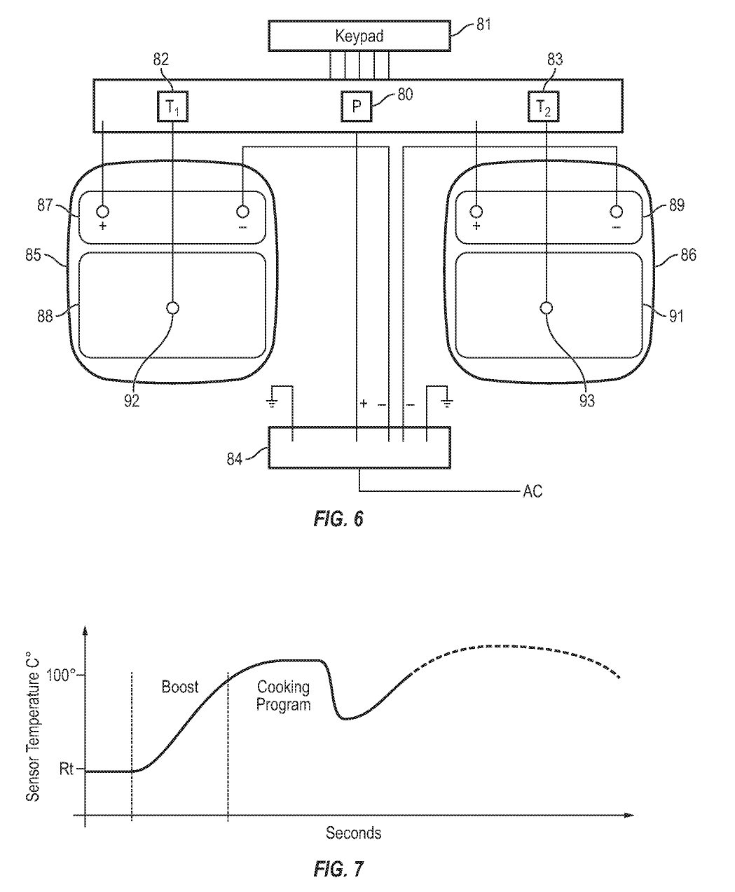

In turning to FIG. 6, a typical schematic of a two-plate cooking apparatus is illustrated. Specifically, keypad 81 is available to a user enabling the user to choose the appropriate egg size (small, medium, large) and cooking program (soft, fully cooked, soufflé). Information entered on the keypad is introduced to processor 80 which powers Triacs 82 and 83. AC power is introduced at 84 which powers the heating elements which are located beneath first recesses 87/89 which will contain water for conversion to steam and second recesses 88/91 which will be used as cooking zones which include sensors 92/93. Connection of the heaters to the AC power is generally made under recesses 87/89 as shown.

The appliance can also include a proportional control which checks how fast the second recess reaches its target temperature. If the sensor detects a too rapid rise in temperature, this is indicative of an egg which is smaller than anticipated causing power to be reduced by 50%. This is helpful when a user improperly enters the egg size at commencement of the cooking cycle. Either way, once preheat has been completed the cooking cycle is carried out as previously described whereby energy is applied to the first heating element to initiate steam production for a predetermined period of time by applying a “boost” followed by cooking at reduced power. What follows is a power interruption in order to slow steam production culminating in a dwell period as steam is produced by virtue of the temperature of the first plate.

As noted, souffléing the largest eggs requires 180 seconds of steam generation which usually involves conversion of about 10 ml of water to steam. With that in mind, the appropriate size of the first recess should be at least 20 ml in volume.

In summarizing the operation of the present appliance, a user would select the egg size such a small, medium or large and a program such as poached, fast or completely cooked or souffléd. The processor is programed to remember the last user settings so that repeatability is enhanced although such settings can be changed at the desire of the user. Once the user presses the “go” button, the preheat cycle begins. Typically, if the device sits at room temperature (20° C.) power is supplied to the second plate in order to raise its temperature to the target of 100° C. However, prior to reaching the target temperature, after a few seconds, the processor will know whether an egg is in the second recess by recognizing the temperature increase based upon the power applied to the second plate through the activation of the second heater. For example, after five seconds, if there was no egg present, the second plate would be at 45° C. but if an egg was present, the temperature would rise to only about 35° C. Once it is recognized an egg is present, power is increased to both heaters. If the temperature rise of either the first or second plates is too rapid, the processor will reduce power by, for example, 50%. When the egg is detected, the processor calculates the temperature drop before the boost phase begins. After the “boost phase”, the cooking cycle begins. By way of illustration, if one was to have a medium-size egg for poaching, power is supplied at 75% of maximum for 20 seconds and 35% for 30 seconds. There is then a dwell time of 10 seconds as the first plate will continue to produce steam while cooling down which further assists in preparing for the next cooking cycle. As such, as to this example, the total cooking time is 60 seconds.

The discussion contained in the previous paragraph assumed that a de-shelled egg was contained within the second recess prior to commencement of the process. However, as noted previously, the present device is capable of determining whether that is the case and in dealing with situations in which there is no de-shelled egg in the second recess prior to commencement. As was the case previously, a user would select egg size and program and press a “go” button to start the preheat cycle. As was the case previously, the system monitors plate temperature and, based upon this, determines that there was no egg detected. After reaching a preheat temperature of 100° C., the system maintains its temperature for two minutes and if no egg is detected, power to the second plate terminates. However, within this time period, an egg and water can be applied to the second and first recesses, respectively. Once the preheat portion of the process is completed, the “boost” and cooking cycles are carried out as was previously described.

It is quite apparent from the above discussion that what has been disclosed is an appliance which can be used to cook eggs of varying sizes involving cooking programs which enable a user to repeatedly achieve desired results. This device removes all guess-work from the process. In doing so, the device recognizes whether an egg has been placed within the device initially when the egg and device are at room temperature or whether the device is devoid of an egg during a prescribed preheat cycle and adjusts the time/temperature profiles from preheat, boost to cooking while metering the appropriate steam production to achieve the appropriate end result.

The above disclosure is sufficient to enable one of ordinary skill in the art to practice the invention, and provides the best mode of practicing the invention presently contemplated by the inventor. While there is provided herein a full and complete disclosure of the preferred embodiments of the invention, it is not desired to limit the invention to the exact construction, dimensions, relationships, or operations as described. Various modifications, alternative constructions, changes and equivalents will readily occur to those skilled in the art and may be employed as suitable without departing from the true spirit and scope of the invention. Such changes might involve alternative materials, components, structural arrangements, sizes, shapes, forms, functions, operational features or the like. Therefore, the above description and illustration should not be considered as limiting the scope of the invention, which is defined by the appended claims.

What is claimed is:

1. An egg cooking appliance comprising a first recess for the receipt of water, said first recess further comprising a first heater positioned below said first recess;
a second recess for the receipt of at least one de-shelled egg, further comprising a second heater positioned below said second recess, said first and second heaters being either separate elements or a single continuous element below both first and second recesses
a temperature sensor affixed to said second recess and distanced from said second heater;
a processor for the receipt of input from a user and from said temperature sensor for providing output to said first and second heaters; and
a lid sized to substantially cover said first and second recesses and for passage of steam from said first recess to said second recess and for expelling steam from said appliance.

2. The appliance of claim 1 wherein said first recess is of a size and said first heater is of a power to enable said appliance to produce steam delivered to said second recess for approximately up to 180 seconds.

3. The appliance of claim 1 wherein said first and second heaters are approximately of equal power output.

4. The appliance of claim 3 wherein each of said first and second heaters provide approximately 500 W of power.

5. The appliance of claim 1 wherein said sensor detects the presence of a de-shelled egg in said second recess by detecting the rate of temperature increase when power is provided to said second heater.

6. The appliance of claim 5 wherein said processor begins a preheat cycle when the appliance is activated by a user and turns off power to said first and second heaters if an egg has not been introduced to said second recess.

7. The appliance of claim 6 wherein said processor initiates a power boost to said first and second heaters after said preheat cycle to commence a cooking cycle.

8. The appliance of claim 7 wherein said processor controls the length of said cooking cycle as a result of the mass of said at least one de-shelled egg and user selected cooking characteristics of said at least one de-shelled egg.

9. The appliance of claim 1 wherein said processor periodically terminates power to said first heater for regulation of steam generation from said first recess.

10. The appliance of claim 1 wherein said first and second recesses are configured within a single plate.

11. The appliance of claim 1 wherein said first and second recesses are configured within individual plates, said plates being housed in a frame to enable said plates to be individually removed from said frame.

12. The appliance of claim 1 wherein said first recess is shaped so that as long as there is water in said first recess, said water is always proximate said first heater.

13. The appliance of claim 1 wherein said second recess is characterized as being approximately 10 mm in depth having a volume of approximately 100 ml.

14. The appliance of claim 1 wherein said first recess is of a size to receive at least approximately 20 ml of water.

15. The appliance of claim 10 wherein said plate is comprised of aluminum and said lid is comprised of stainless steel.

16. The appliance of claim 11 wherein said individual plates are comprised of aluminum and said lid is comprised of stainless steel.

17. The appliance of claim 1 wherein said processor is configured to receive the approximate size of the egg to be introduced within the second recess by a user.

18. The appliance of claim 1 wherein said processor is configured to receive an intended degree of cooking of said de-shelled egg by a user.

19. The appliance of claim 18 wherein said degree of cooking provides for a de-shelled egg to be soft poached, fully cooked or souffléd.

20. An egg cooking appliance comprising a first recess for the receipt of water, said first recess further comprising a first heater positioned below said first recess;
a second recess for the receipt of at least one de-shelled egg, further comprising a second heater positioned below said second recess, said first and second heaters being either separate elements or a single continuous element below both first and second recesses;
a temperature sensor affixed to said second recess responsive to the temperature of said second recess and distanced from said second heater;
a lid sized to substantially cover said first and second recesses and for passage of steam from said first recess to said second recess and for expelling steam from said appliance;
a processor;
a keypad providing user—selected output of egg sizes and cooking preferences to said processor;
said processor activating said second heater for initiating pre-heating of said second recess; and
said sensor providing temperature information to said processor.

21. The egg cooking appliance of claim 20 wherein said sensor provides temperature information to said processor sufficient to enable the cooking appliance to know whether a de-shelled egg is contained in the second recess.

22. The egg cooking appliance of claim 21 wherein when said second recess contains a de-shelled egg, said processor causing said first heater to increase the temperature of said first recess to at least 100° C. for the production of steam.

23. The egg cooking appliance of claim 22 wherein said processor controls power to said first and second heaters based upon said user-selected egg size and cooking preference.

24. The egg cooking appliance of claim 20 wherein said processor retains egg size and cooking preferences upon completion of a cooking cycle.

25. The egg cooking appliance of claim 20 wherein said processor monitors the temperature of said second recess through said sensor and adjusts power to said second heater if an egg contained within said second recess differs in mass from the egg size entered by a user through said key pad.
